(19) United States
(12) Patent Application Publication
(10) Pub. No.: US 2009/0115945 A1
(43) Pub. Date: May 7, 2009

(54) POLARIZING PLATE, METHOD FOR MANUFACTURING THE POLARIZING PLATE, LAMINATED OPTICAL MEMBER, AND LIQUID CRYSTAL DISPLAY DEVICE

(75) Inventors: Yuuhei Inokuchi, Ehime (JP); Yoshiki Matsuoka, Ehime (JP); Yuichiro Kunai, Ehime (JP); Hideo Kuroiwa, Ehime (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku, Tokyo (JP)

(21) Appl. No.: 12/300,810

(22) PCT Filed: May 15, 2007
(86) PCT No.: PCT/JP2007/060314

§ 371 Date: Dec. 11, 2008

(30) Foreign Application Priority Data
May 17, 2006 (JP) 2006-137473

(51) Int. Cl. G02F 1/1335; G02B 1/08; B29D 11/00

(52) U.S. Cl. 349/96; 359/500; 264/1.34

(57) ABSTRACT

This invention provides a polarizing plate comprising a polarizer formed of a polyvinyl alcohol resin on which a dichroic dye is adsorbed and aligned. A protective film is stacked on both sides of the polarizer. At least one of the protective films is formed of a propylene resin. In stacking the protective film formed of propylene resin on at least one side of the polarizer, a method is advantageously adopted that the protective film on its surface to be applied onto the polarizer is subjected to corona discharge treatment and the polarizer is applied onto the treated face through an adhesive.

### TECHNICAL FIELD

The present invention relates to a polarizing plate prepared by laminating protective films on both surfaces of a polarizer and to a method for manufacturing the polarizing plate. The present invention also relates to a laminated optical member obtained by laminating other optical layers on the polarizing plate and also to a liquid crystal display device using the polarizing plate or the laminated optical member.

### BACKGROUND ART

Liquid crystal display devices have the characteristics that they are reduced in power consumption, work at lower voltages and are light-weight and thin and are used for various display devices by making use of these characteristics. Each of these liquid crystal display devices is constituted of many materials such as a liquid crystal cell, a polarizing plate, a phase difference film, a converging sheet, a diffusion film, a light guide plate and a light reflecting sheet. For this reason, improvements aiming at high productivity, light-weight and brightness are enthusiastically made by reducing the number of structural films or by reducing the thickness of a film or a sheet.

In the meantime, products that can stand strict endurance conditions are required depending on use. For example, a liquid crystal display device for car navigation systems is exposed to more strict temperature and moisture circumstances than monitors for general televisions and personal computers because the temperature and moisture in vehicles where the liquid crystal display devices are placed are sometimes higher. In such uses, highly durable polarizing plates are required.

A polarizing plate generally has a structure in which a transparent protective film is laminated on one or both surfaces of a polarizer made of a polyvinyl alcohol resin with a dichroic dye adsorbed thereto and aligned thereon. The polarizer is manufactured by a method in which a polyvinyl alcohol resin film is subjected to vertical uniaxial stretching and to dying using a dichroic dye, and then treated with boric acid to undergo a crosslinking reaction, followed by washing with water and drying. As the dichroic dye, iodine or dichroic organic dyes are used. A protective film is laminated on one or both surfaces of the obtained polarizer to make a polarizing plate, which is then incorporated into a liquid crystal display device for use. As the protective film, a resin film of cellulose acetate typified by triacetylcellulose is frequently used, and the thickness of the film is generally about 30 to 120 μm. Also, in the lamination of the protective film, an adhesive constituted of an aqueous solution of a polyvinyl alcohol resin is frequently used.

The polarizing plate obtained by laminating the protective film made of triacetylcellulose on one or both surfaces of the polarizer with a dichroic dye adsorbed thereto and aligned thereon with an adhesive constituted of an aqueous solution of a polyvinyl alcohol resin tends to be deteriorated in polarizing performance and easily gives rise to peeling of the protective film from the polarizer when the polarizing plate is used under moistened and heated conditions for a long period of time.

In light of this, an attempt is made to constitute at least one protective film by using a resin except for a cellulose acetate resin. For example, in JP-A No. 8-43812, there are the descriptions that in a polarizing plate with protective films laminated on both surfaces of a polarizer, at least one protective film is constituted of a thermoplastic norbornene resin having the function of a phase difference film. Also, in JP-A No. 2002-174729, there are the descriptions as to a polarizing plate obtained by laminating a protective film made of an amorphous polyolefin resin on one surface of a polarizer made of a polyvinyl alcohol resin film with iodine or a dichroic organic dye adsorbed thereto and aligned thereon and by laminating a protective film made of a resin, such as a cellulose acetate resin, different from the amorphous polyolefin resin on the other surface. Moreover, in JP-A No. 2004-334168, there are the descriptions that a protective film made of a cycloolefin resin is laminated on a polyvinyl alcohol polarizer with an adhesive containing a urethane adhesive and a polyvinyl alcohol resin.

However, the amorphous polyolefin resin (cycloolefin resin) such as a norbornene resin has recently been put into practical use and is therefore generally expensive. Also, the amorphous polyolefin resin is easily eroded by organic solvents such as acetone, toluene and ethyl acetate.

These organic solvents are used for the preparation of pressure-sensitive adhesives and sometimes left therein.

The inventors of the present invention have ascertained that in a polarizing plate obtained by laminating protective films made of a cellulose acetate resin on both surfaces of a polyvinyl alcohol polarizer with a dichroic dye adsorbed thereto and aligned thereon, the peeling of the protective films from the polarizer under moistened and heated conditions is caused by the dimensional change and moisture permeability of the cellulose acetate resin film under moistened and heated conditions. Then, the inventors have found that because propylene resin films which have been conventionally generally used in the industrial field are reduced in dimensional change, have low moisture permeability under such a circumstance, are excellent in resistance to organic solvents and are, also, available at low costs, these films are effective as the protective film of the polarizing plate.

Also, the inventors have found that though a propylene resin has unsatisfactory adhesion to a polarizer made of a polyvinyl alcohol resin because it has no polar group in its structure, it firmly adheres to the polarizer by using a proper adhesive if its surface is subjected to corona discharge treatment. The inventors have also found that a polarizing plate with a propylene resin applied to at least one surface thereof as the protective film is more resistant to the peeling of the protective film under moistened and heated conditions as compared with the conventional polarizing plate in which cellulose acetate resin films are applied to both surfaces of the polarizer. The present invention has been made based on these findings.

It is an object of the present invention is to provide a polarizing plate obtained by laminating a protective film on both surfaces of a polarizer with a dichroic dye adsorbed thereto and aligned thereon, the polarizing plate being superior in dimensional stability particularly under moistened and heated conditions, being resistant to a reduction in the adhesion between the polarizer and the protective film and having high solvent resistance can be provided at low costs by constituting at least one of the protective films by using a resin film which is reduced in dimensional change, has low moisture permeability, is resistant to organic solvents such as acetone, toluene and ethyl acetate and is available at low costs. Another object of the present invention is to provide a method for advantageously manufacturing such a polarizing plate. A further object of the present invention is to provide a laminated optical member useful for being applied to a liquid crystal cell by laminating this polarizing plate on an optical layer exhibiting other optical functions. A still further object of the present invention is to apply the polarizing plate or the laminated optical member to a liquid crystal display device.

### DISCLOSURE OF THE INVENTION

According to the present invention, there is provided a polarizing plate including a polarizer made of a polyvinyl alcohol resin with a dichroic dye adsorbed thereto and aligned thereon and protective films laminated on both surfaces of the polarizer, wherein at least one of the protective films is made of a propylene resin.

In this polarizing plate, al though the protective film laminated on each surface of the polarizer may be constituted of the above propylene resin film, a protective film made of a propylene resin film may be laminated on one surface of the polarizer and a protective film made of a resin other than a propylene resin may be laminated on the other surface. In the latter case, it is advantageous that the resin other than a propylene resin is constituted of a cellulose acetate resin such as triacetylcellulose. These polarizing plates may be manufactured as polarizing plates with a pressure-sensitive adhesive by forming a pressure-sensitive adhesive layer on the outside of one of the protective films.

Also, according to the present invention, there is provided a method for manufacturing a polarizing plate, including laminating a protective film made of a propylene resin on at least one surface of a polarizer made of a polyvinyl alcohol resin with a dichroic dye adsorbed thereto and aligned thereon, wherein when the protective film is laminated, the surface of the protective film made of the propylene resin, which surface is to be applied to the polarizer, is subjected to corona discharge treatment and then the polarizer is applied to the treated surface with an adhesive.

Further, according to the present invention, there is also provided a laminated optical member including a laminate of the polarizing plate and an optical layer having other optical functions.

Also, according to the present invention, there is provided a liquid crystal display device including the polarizing plate or laminated optical member applied to a liquid crystal cell with a pressure-sensitive adhesive.

### BRIEF DESCRIPTION OF THE DRAWING

FIG. 1 is a plan view schematically showing the situation where a color void is developed in a warm-water dipping test.

### DESCRIPTION OF THE SYMBOLS

1 Part where the color specific to a polarizing plate is left
2 Part where a color is lost
5 Holding part
X Amount of color voids

### BEST MODE FOR CARRYING OUT THE INVENTION

The present invention will be explained in detail. The polarizing plate of the present invention is obtained by laminating protective films on both surfaces of a polarizer, wherein at least one of these protective films is constituted of a propylene resin.

### [Polarizer]

The polarizer is one so devised that it has prescribed polarizing characteristics by allowing a dichroic dye to be adsorbed to and aligned on a polyvinyl alcohol resin film. As the dichroic dye, iodine or a dichroic organic dye is used. In this case, specific examples of the polarizer include an iodine type polarizing film obtained by allowing iodine to be adsorbed to and aligned on a polyvinyl alcohol resin film and a dye type polarizing film obtained by allowing a dichroic dye to be adsorbed to and aligned on a polyvinyl alcohol resin film.

The polyvinyl alcohol resin is obtained by saponifying a polyvinyl acetate resin. As the polyvinyl acetate resin, copolymers of vinyl acetate and other monomers copolymerizable therewith besides polyvinyl acetate, which is a homopolymer of vinyl acetate, are used. Examples of these other monomers to be copolymerized with vinyl acetate include unsaturated carboxylic acids, olefins, vinyl ethers and unsaturated sulfonic acids. The polyvinyl alcohol resin may be modified and, for example, polyvinyl formal, polyvinyl acetal and polyvinyl butyral which are modified by aldehydes may be used.

The polarizing plate is generally manufactured through a humidity conditioning step of controlling the water content of a polyvinyl alcohol resin film, a step of stretching the polyvinyl alcohol resin film uniaxially, a step of dying the polyvinyl alcohol resin film with a dichroic dye to adsorb the dichroic dye, a step of treating the polyvinyl alcohol resin film with the dichroic dye adsorbed thereto and aligned thereon by using an aqueous boric acid solution, a washing step of washing out the aqueous boric acid solution and a step of applying a protective film to the uniaxially stretched polyvinyl alcohol resin film with the dichroic dye adsorbed thereto and aligned thereon through these steps.

The uniaxial stretching may be carried out before or during the dying step or during the treatment using boric acid after the dying step. Also, there is the case where the resin film is uniaxially stretched in these plural steps. In the uniaxial stretching, the film may be uniaxially stretched by passing the film between rolls differing in circumferential speed or by using a heat roll. Also, the uniaxial stretching may be either dry stretching performed in the air or wet stretching performed in the condition where the dichroic dye is swelled by a solvent. The stretching ratio is generally about 4 to 8. The thickness of the polyvinyl alcohol polarizer is, for example, about 5 to 50 μm.

### [Propylene Resin]

In the present invention, protective films are laminated on both surfaces of such a polyvinyl alcohol polarizer. In this case, at least one of these protective films is constituted of a propylene resin to make a polarizing plate. The propylene resin means a resin primarily constituted of a unit of propylene and is generally a crystalline one. The propylene resin may be a copolymer of propylene and a comonomer copolymerizable therewith besides a homopolymer of propylene.

The comonomer to be copolymerized with propylene may be ethylene or an α-olefin having 4 to 20 carbon atoms. Specific examples of the α-olefin include the following ones.

1-butene and 2-methyl-1-propene (C4);

1-pentene, 2-methyl-1-butene and 3-methyl-1-butene (C5);

1-hexene, 2-ethyl-1-butene, 2,3-dimethyl-1-butene, 2-methyl-1-pentene, 3-methyl-1-pentene, 4-methyl-1-pentene and 3,3-dimethyl-1-butene (C6);

1-heptene, 2-methyl-1-hexene, 2,3-dimethyl-1-pentene, 2-ethyl-1-pentene, 2-methyl-3-ethyl-1-butene (C7);

1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyl-1-pentene and 2,3-diethyl-1-butene (C8);

1-nonene (C9); 1-decene (C10); 1-undecene (C11); 1-dodecene (C12); 1-tridecene (C13); 1-tetradecene (C14);

1-pentadecene (C15); 1-hexadecene (C16); 1-heptadecene (C17); 1-octadecene (C18); and 1-nonadecene (C19).

Among these α-olefins, α-olefins each having 4 to 12 carbon atoms are preferable. Specific examples of the α-olefins include 1-butene, 2-methyl-1-propene; 1-pentene, 2-methyl-1-butene, 3-methyl-1-butene; 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene; 1-heptene, 2-methyl-1-hexene, 2,3-dimethyl-1-pentene, 2-ethyl-1-pentene, 2-methyl-3-ethyl-1-butene; 1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyl-1-pentene and 2,3-diethyl-1-butene; 1-nonene; 1-decene; 1-undecene; and 1-dodecene. From the viewpoint of copolymerizability, 1-butene, 1-pentene, 1-hexene and 1-octene are preferable, and particularly, 1-butene and 1-hexene are more preferable.

The copolymer may be a random copolymer or a block copolymer.

Preferable examples of the copolymer include a propylene/ethylene copolymer and a propylene/1-butene copolymer. In these propylene/ethylene copolymer and propylene/1-butene copolymer, the content of an ethylene unit or a 1-butene unit can be found by measuring the infrared (IR) spectrum according to the method described in, for example, “Polymer Analysis Handbook” published by Kinokuniya Shoten in 1995, page 616.

The copolymer is preferably a random copolymer of propylene used as a primary component and optionally unsaturated hydrocarbons from the viewpoint of improving the transparency and processability required for the protective film of the polarizing plate. Among these copolymers, a copolymer of propylene and ethylene is preferable. When producing a copolymer, it is advantageous that the copolymerization ratio of unsaturated hydrocarbons other than propylene is designed to be about 1 to 10% by weight and preferably 3 to 7% by weight. When the amount of a unit of these unsaturated hydrocarbons other than propylene is 1% by weight or more, the effect of improving the processability and transparency tends to be produced. However, when the ratio exceeds 10% by weight, this is undesirable because there is a tendency that the melting point of the resin drops and the heat resistance of the polymer is deteriorated. In the case of using two or more types of comonomers and propylene to form a copolymer, the total content of units derived from all comonomers contained in the copolymer is preferably in the above range.

The propylene resin may be produced by a method in which propylene is homopolymerized by using a known polymerization catalyst or by a method in which propylene is copolymerized with other copolymerizable comonomers. Examples of the known polymerization catalyst include the following compounds.

(1) A Ti—Mg catalyst constituted of a solid catalyst component containing magnesium, titanium and halogen as essential components.

(2) A catalyst type obtained by combining a solid catalyst component containing magnesium, titanium and halogen as essential components, with an organic aluminum compound and as required, a third component such as an electron-donating compound.

(3) Metallocene catalysts

Among these catalyst types, the catalyst type obtained by combining a solid catalyst component containing magnesium, titanium and halogen as essential components, with an organic aluminum compound and an electron-donating compound may be most usually used for the manufacture of the propylene resin used for the protective film of the polarizing plate according to the present invention. To explain more specifically, preferable examples of the organic aluminum compound include triethylaluminum, triisobutylaluminum, a mixture of triethylaluminum and diethylaluminum chloride and tetraethyldialmoxane. Preferable examples of the electron-donating compound include cyclohexylethyldimethoxysilane, tert-butylpropyldimethoxysilane, tert-butylethyldimethoxysilane and dicyclopentyldimethoxysilane.

On the other hand, examples of the solid catalyst component containing magnesium, titanium and halogen as essential components include catalyst types as described in JP-A Nos. 61-218606, 61-287904 and 7-216017. Examples of the metallocene catalyst include catalyst types as described in JP Nos. 2587251, 2627669 and 2668732.

The propylene resin may be produced, for example, by the solution polymerization method using inert solvents typified by hydrocarbon compounds such as hexane, heptane, octane, decane, cyclohexane, methylcyclohexane, benzene, toluene and xylene, the block polymerization method using a liquid monomer as a solvent or the vapor phase polymerization method in which a gaseous monomer is directly polymerized. The polymerization using these methods may be carried out in a batch system or a continuous system.

The tacticity of the propylene resin may be any of isotactic, syndiotactic and atactic. In the present invention, a syndiotactic or isotactic polypropylene resin is preferably used from the viewpoint of heat resistance.

The propylene resin to be used in the present invention has a melt flow rate (MFR) in the range of, preferably, 0.1 to 200 g/10 min. and more preferably 0.5 to 50 g/10 min., when measured in the condition of a temperature of 230° C. and a load of 21.18 N according to JIS K7210. The use of the polypropylene resin having a MFR falling in the above range ensures that a uniform film-like product can be obtained without applying a large load on an extruder.

The propylene resin may be formulated with known additives to the extent that the effect of the present invention is not impaired. Examples of the additive include an antioxidant, an ultraviolet absorber, antistatic agent, a lubricant, a core forming agent, an anti-clouding agent and an anti-blocking agent. Examples of the antioxidant include phenolic antioxidants, phosphorous antioxidants, sulfur antioxidants and hindered amine photo-stabilizers. Also, complex antioxidants containing a unit having a phenolic oxidation preventive mechanism and a phosphorous oxidation preventive mechanism in one molecule may be used. Examples of the ultraviolet absorber include 2-hydroxybenzophenone and hydroxyphenylbenzotriazole ultraviolet absorbers and benzoate ultraviolet cut-off agents. The antioxidant may be any of a polymer type, an oligomer type and a monomer type. Examples of the lubricant include higher fatty acid amides such as erucic acid amide and oleic acid amide and higher fatty acids such as stearic acid and their salts. Examples of the core forming agent include a sorbitol core forming agent, an organic phosphate core forming agent and a polymeric core forming agent such as polyvinylcycloalkane. As the anti-blocking agent, microparticles having a spherical shape or a similar shape may be used whether they are inorganic or organic. These additives may be used in combinations of two or more.

### [Propylene Resin Film]

In the present invention, the aforementioned propylene resin is formed into a film and the resulting film is used as the protective film of the polarizing plate. This protective film is transparent and has almost no in-plane phase difference. A propylene resin film having almost no in-plane phase difference can be obtained using, for example, the extrusion molding method using a molten resin or the solvent cast method in which a resin dissolved in an organic solvent is cast on a flat plate and the solvent is then removed to form a film.

The method of producing a film by extrusion molding will be explained in detail. The propylene resin is molten and kneaded by the rotation of a screw in an extruder and then extruded in a sheet form from a T-die. The temperature of the extruded molten sheet is about 180 to 300° C. When the temperature of the molten sheet is less than 180° C., there is the possibility that only insufficient extendibility is obtained, so that the thickness of the obtained film is non-uniform, resulting in the production of a film having an uneven phase difference. Also, if the temperature exceeds 300° C., this causes the resin to be deteriorated and decomposed with ease and there is therefore the case where air bubbles are produced and carbides are contained in the sheet.

The extruder may be a uniaxial extruder or a biaxial extruder. In the case of, for example, a uniaxial extruder, a screw such as a full freight type, a barrier type or a type having a Madoc type kneading part wherein the ratio (L/D) of the length L to the diameter D of the screw is about 24 to 36, and the ratio (compression ratio) of the space volume of the thread groove in the resin supply section to the space volume of the thread groove in the resin metering section (the former/the latter) is about 1.5 to 4 is preferably used. It is preferable to use a barrier type screw in which the ratio of L/D is 28 to 36 and the compression ratio is 2.5 to 3.5 from the viewpoint of suppressing the deterioration and decomposition of the propylene resin and melting and kneading uniformly. Also, in order to suppress the deterioration and decomposition of the propylene resin as much as possible, the inside of the extruder is preferably a nitrogen atmosphere or is vacuumed. In order to remove the vaporized gas generated as a result of the deterioration and decomposition of the propylene resin, it is preferable to provide an orifice (1 mmφ or more and 5 mmφ or less) at the head of the extruder to raise the pressure of the resin at the head of the extruder. The description “to raise the pressure of the resin at the head of the extruder” means a rise in the back pressure at the head, thereby making it possible to improve the stability of the extrusion. The diameter of the orifice to be used is more preferably 2 mmφ or more and 4 mmφ or less.

The T-die to be used for the extrusion is preferably one which is free from minute steps and scratches on the surface of the resin passage and also has a lip part plated or coated with a material having a small coefficient of friction with the molten propylene resin and also has a lip provided with the top part having the form of a sharp edge abraded into a size of 0.3 mmφ or less. Examples of materials having a small coefficient of friction include special plating of tungsten carbide or fluorine. The generation of pitches can be limited by using such a T-die and at the same time, the die line is limited and therefore, a resin film superior in the uniformity of outward appearance is obtained. This T-die is preferably provided with a manifold having a coat hanger form and also preferably satisfies the following requirement (1) or (2) and also the requirement (3) or (4)

When the lip width of the T-die is less than 1500 mm: Length of the T-die in the direction of the thickness >180 mm

(1)

When the lip width of the T-die is 1500 mm or more: Length of the T-die in the direction of the thickness >220 mm

(2)

When the lip width of the T-die is less than 1500 mm: Length of the T-die in the direction of the height >250 mm (3)

When the lip width of the T-die is 1500 mm or more: Length of the T-die in the direction of the height >280 mm (4)

The use of a T-die satisfying such requirements ensures that the flow of the molten propylene resin inside of the T-die can be arranged and also, the resin can be extruded while limiting thickness unevenness also at the lip part, enabling the preparation of a protective film having higher thickness precision and more uniform phase difference.

A gear pump is preferably installed between the extruder and the T-die through an adapter from the viewpoint of suppressing variation in the extrusion of the propylene resin. Also, a leaf disk filter is preferably installed to remove foreign matters present in the propylene resin.

The molten sheet extruded from the T-die is allowed to pass between a metal cooling roll (also called a chill roll or a casting roll), a touch roll including an elastic body and rotated in the direction of the circumference of the metal cooling roll in contact with the cooling roll with pressure to cool and solidify the sheet, whereby a desired film can be obtained. At this time, the touch roll may be a roll of which surface is either constituted of an elastic body such as a rubber or coated with an outer casing constituted of a metal sleeve, When the touch roll of which surface is coated with an outer casing constituted of a metal sleeve is used, the molten sheet of the propylene resin is usually directly sandwiched between the metal cooling roll and the touch roll to cool the sheet.

When the touch roll of which surface is elastic is used, the propylene resin molten sheet is allowed to pass through these rolls with pressure interposing a biaxially stretched film made of a thermoplastic resin.

When the propylene resin molten sheet is sandwiched between the above cooling roll and the touch roll to cool and solidify the sheet, it is necessary that each temperature of both rolls is made to be lowered to thereby quickly cool the molten sheet. Specifically, each surface temperature of the above both rolls is regulated in a range of from 0° C. to 30° C. When the surface temperatures of these rolls exceed 30° C., it takes time to cool and solidify the molten sheet, so that crystal components contained in the propylene resin grow, with the result that the obtained film lacks transparency. When the surface temperatures of these rolls are less than 0° C. on the other hand, there is a tendency that the surface of the metal cooling roll is bedewed, so that water droplets are deposited, causing a tendency that the appearance of the film to be impaired.

There is the possibility that the metal cooling roll to be used deteriorates the thickness precision of the propylene resin film when the surface is irregular because the surface condition of the roll is transferred to the surface of the propylene resin film. Therefore, the surface of the metal cooling roll is preferably put into a mirror state as much as possible. Specifically, the roughness of the surface of the metal cooling roll is preferably 0.3 S or less and more preferably 0.1 S to 0.2 S when it is expressed by the standard sequence of maximum heights.

The surface hardness of each elastic body of the metal cooling roll and the touch roll forming the nip part is preferably 65 to 80 and more preferably 70 to 80 when measured according to the spring type hardness test (A model) prescribed in JIS K 6301. When a rubber roll having such a surface hardness is used, the linear pressure applied to the molten sheet is easily uniformly kept and a film is easily molded without forming a bank (resin bank) for the molten sheet between the metal cooling roll and the touch roll.

The pressure (linear pressure) applied when the molten sheet is sandwiched with pressure is determined by the pressure with which the touch roll is pressed against the metal cooling roll. The linear pressure is designed to be preferably 50 N/cm or more and 300 N/cm or less and more preferably 100 N/cm or more and 250 N/cm or less. When the linear pressure is in the above range, the propylene resin film can be easily manufactured with maintaining a fixed linear pressure without forming any bank.

When the biaxially stretched film made of a thermoplastic resin is sandwiched with pressure together with the propylene resin molten sheet between the metal cooling roll and the touch roll, any resin may be used as the thermoplastic resin constituting this biaxially stretched film insofar as it is not firmly and thermally fused with the propylene resin. Specific examples of the biaxially stretched film include a polyester, a polyamide, polyvinyl chloride, polyvinyl alcohol, an ethylene/vinyl alcohol copolymer and polyacrylonitrile. Among these materials, a polyester reduced in dimensional change caused by humidity and heat is most preferable. The thickness of the biaxially stretched film in this case is generally about 5 to 50 μm and preferably 10 to 30 μm.

In this method, the distance (air gap) from the lip of the T-die to the position where the molten sheet is sandwiched between the metal cooling roll and the touch roll is designed to be 200 mm or less and more preferably 160 mm or less. The molten sheet extruded from the T-die is stretched between the lip and the roll, bringing about easy orientation. A film more reduced in orientation can be obtained by decreasing the air gap as mentioned above. The lower limit of the air gap is, determined by the diameter of the metal cooling roll to be used, the diameter of the touch roll to be used and the head shape of the lip to be used and is generally 50 mm or more.

The processing speed when the propylene resin film is manufactured by this method is determined according to the time required to cool and solidify the molten sheet. When the diameter of the metal cooling roll is increased, the distance between which the molten sheet is in contact with the cooling roll is increased, enabling production at a higher speed. Specifically, when a 600 mmφ metal cooling roll is used, the maximum processing speed is about 5 to 20 m/min.

The molten sheet sandwiched with pressure between the metal cooling roll and the touch roll is cooled and solidified by being brought into contact with the rolls. Then, the end part is slit depending on the need and the sheet is wound by a winder to form a film. At this time, in order to protect the surface until the film is used, the film may be wound in the condition that a surface protective film made of another thermoplastic resin is applied to one or both surfaces of the film. When the propylene resin molten sheet is sandwiched with pressure between the metal cooling roll and the touch roll together with a biaxially stretched film made of a thermoplastic resin, the biaxially stretched film may serve as one of the surface protective films.

In the present invention, the protective film constituted of the propylene resin laminated on the polarizer is a sheet which is superior in transparency and has small orientation, that is, a sheet with small phase difference. Specifically, as to the transparency of the protective film, the total haze value measured according to JIS K 7105 is 10% or less and preferably 7% or less. Also, the in-plane phase difference is generally 20 nm or less, preferably 10 nm or less, more preferably 7 nm or less and even more preferably 5 nm or less. It is only required that the film forming condition and thickness of the film are appropriately selected such that the haze value and the phase difference value of the obtained base roll sheet fall in the above ranges.

The protective film made of the propylene resin has a thickness of preferably about 5 to 200 μm and more preferably 10 μm or more and 150 μm or less.

### [Polarizing Plate and Manufacture Thereof]

Though the protective films made of a propylene resin may be laminated on both surfaces of a polyvinyl alcohol polarizer, it is effective to laminate a protective film made of a propylene resin on one surface and a protective film made of a resin other than the propylene resin on the other surface. Examples of the resin other than the propylene resin include cellulose acetate resins such as triacetylcellulose and diacetylcellulose, polyester resins, acrylic resins and polycarbonate resins. A cellulose acetate resin film and particularly, a triacetylcellulose film is preferably used in consideration of easiness of adhesion to a polarizing film and easiness of formation of a surface treating layer. When a cellulose acetate resin film is used as the protective film, it is preferable to saponify the surface of the film by using an aqueous alkali solution prior to the application of the film to the polarizer. The thickness of the protective film made of a resin other than a propylene resin is generally about 30 to 200 μm, preferably 30 to 120 μm and more preferably 30 to 85 μm. Various surface treating layers such as an antireflection layer and an antiglare layer may be formed on the surface of the protective film on the side opposite to the side applied to the liquid crystal cell.

In order to adhere the polarizer to the protective film made of a propylene resin, an adhesive containing, as its components, an epoxy resin, a urethane resin, a cyanoacrylate resin and an acrylamide resin may be used. Preferable examples of the adhesive include aqueous adhesives, that is, those obtained by dissolving or dispersing adhesive components in water from the viewpoint of forming a thin adhesive layer. Also, other preferable examples of the adhesive include solventless adhesives, that is, those used to react a monomer or an oligomer to cure by heating or irradiation with active energy rays to form an adhesive layer.

First, the aqueous adhesive will be explained. Examples of the adhesive component that can form an aqueous adhesive include water-soluble crosslinkable epoxy resins and urethane resins.

Examples of the water-soluble crosslinkable epoxy resin include polyamide epoxy resins obtained by reacting epichlorohydrin with a polyamide polyamine obtained by reacting a polyalkylene polyamine such as diethylenetriamine or triethylenetetramine with a dicarboxylic acid such as adipic acid. Examples of commercially available products of such a polyamide epoxy resin include “SUMIREZ Resin 650” and “SUMIREZ Resin 675” commercially available from Sumika Chemtex Co., Ltd.

When a water-soluble epoxy resin is used as the adhesive component, it is preferable to blend other water-soluble resins such as a polyvinyl alcohol resin to further improve coatability and adhesiveness. The polyvinyl alcohol resin may be modified polyvinyl alcohol resins such as carboxyl group modified polyvinyl alcohol resins, acetoacetyl group modified polyvinyl alcohol resins, methylol group modified polyvinyl alcohol resins and amino group modified polyvinyl alcohol resins besides partially saponified polyvinyl alcohol resins and fully saponified polyvinyl alcohol resins. Among these compounds, saponified products of copolymers of vinyl acetate, unsaturated carboxylic acid or its salt, that is, carboxyl group modified polyvinyl alcohols are preferably used. The term “carboxyl group” herein is a concept including —COOH and its salts.

Preferable examples of commercially available products of the carboxyl group modified polyvinyl alcohol include “Kuraray Poval KL-506”, “Kuraray Poval KL-318” and “Kuraray Poval KL-1118” commercially available from Kuraray Co., Ltd., “Gosenal T-330” and “Gosenal T-350” commercially available from Nippon Synthetic Chemical Industry Co., Ltd., “DR-0415” commercially available from Denki Kagaku Kogyo Kabushiki Kaisha and “AF-17”, “AT-17” and “AP-17” commercially available from Japan Vam & Poval Co., Ltd.

When using an adhesive containing a water-soluble epoxy resin, the epoxy resin and other water-soluble resins such as a polyvinyl alcohol resin which is added according to the need are dissolved in water to constitute an adhesive solution. In this case, the concentration of the water-soluble epoxy resin is preferably in a range of from about 0.2 to 2 parts by weight based on 100 parts by weight of water. Also, when the above polyvinyl alcohol resin is formulated, the amount of the polyvinyl alcohol resin is preferably about 1 to 10 parts by weight and more preferably about 1 to 5 parts by weight based on 100 parts by weight of water.

In the meantime, when an aqueous adhesive containing a urethane resin is used, proper examples of the urethane resin include ionomer type urethane resins and particularly polyester ionomer type urethane resins. Here, the ionomer type is one obtained by introducing a small amount of ionic components (hydrophilic components) into a urethane resin constituting its skeleton. Also, the polyester ionomer type urethane resin is one having a polyester skeleton, into which a small amount of ionic components (hydrophilic components) are introduced. Such an ionomer type urethane resin is directly emulsified in water without using an emulsifier to form an emulsion and is therefore preferable as the aqueous adhesive. Examples of the polyester ionomer type urethane resin include “Hydran AP-20” and “Hydran APX-101” commercially available from DIC Corporation and these products are available in the form of an emulsion.

When the ionomer type urethane resin is used as the adhesive component, it is generally preferable to formulate a crosslinking agent such as an isocyanate crosslinking agent. The isocyanate crosslinking agent is a compound containing at least two isocyanato groups (—NCO) in its molecule. Examples of this compound include polyisocyanate monomers such as 2,4-tolylenediisocyanate, phenylenediisocyanate, 4,4-diphenylmethanediisocyanate, 1,6-hexamethylenediisocyanate and isophoronediisocyanate, and also include polyisocyanate modified bodies such as adduct bodies obtained by adding a plurality of these molecules to polyhydric alcohols such as trimethylol propane, trifunctional isocyanurate bodies in which three diisocyanate molecules respectively form an isocyanurate ring at the part of one-terminal isocyanato group and burette bodies formed by performing hydration and decarboxylation of three diisocyanate molecules at each one-terminal isocyanato group. Examples of commercially available isocyanate crosslinking agents which are preferably used include “Hydran Assister C-1” commercially available from DIC Corporation.

When an aqueous adhesive containing an ionomer type urethane resin is used, it is preferable to use a dispersion obtained by dispersing this urethane resin in a concentration of about 10 to 70% by weight and preferably 20% by weight or more and 50% by weight or less from the viewpoint of viscosity and adhesiveness. When the isocyanate crosslinking agent is formulated, its amount may be appropriately selected such that the amount of the isocyanate crosslinking agent is about 5 to 100 parts by weight based on 100 parts by weight of the urethane resin.

The aqueous adhesive is applied to the adherend surface of the protective film and/or polarizer made of a propylene resin and the both are applied to each other to produce a polarizing plate. No particular limitation is imposed on a method of applying the polarizer and the protective film to each other. Examples of the method include a method in which the adhesive is uniformly applied to the surface of the polyvinyl alcohol polarizer or the protective film and the other film is overlapped on the coating surface to apply it by a roll or the like, followed by drying. The drying is carried out at about 60 to 100° C. After being dried, the resulting film is preferably cured at a temperature slightly higher than ambient temperature, for example, about 30 to 50° C. for about one to ten days with the view of further improving adhesion.

Next, a solventless adhesive will be explained. The solventless adhesive has a structure in which a significant amount of solvent is not contained and a curable compound that is polymerized by heating or irradiation with active energy rays and a polymerization initiator are generally contained. Adhesives that are cured by cation polymerization are preferable from the viewpoint of reactivity and particularly, an epoxy adhesive is desirably used.

In light of this, in one preferred embodiment of the polarizing plate according to the present invention, a polarizer and a protective film constituted of a propylene resin are laminated with a solventless epoxy adhesive. This adhesive is preferably one cured by cationic polymerization carried out by heating or irradiation with active energy rays. Particularly, an epoxy compound containing no aromatic ring in its molecule is preferably used as the curable compound from the viewpoint of weatherability and refractive index. An adhesive using an epoxy compound containing no aromatic ring in its molecule is described in, for example, JP-A No. 2004-245925. As such an epoxy compound containing no aromatic ring, hydrides of aromatic epoxy compounds, alicyclic epoxy compounds and aliphatic epoxy compounds may be exemplified. The curable epoxy compound used as an adhesive generally has two epoxy groups in its molecule.

To explain the hydride of an aromatic epoxy compound, this hydride may be obtained by allowing an aromatic epoxy compound to undergo a hydrogenation reaction with the aromatic ring selectively under pressure in the presence of a catalyst. Examples of the aromatic epoxy compound include bisphenol type epoxy compounds such as diglycidyl ether of bisphenol A, diglycidyl ether of bisphenol F and diglycidyl ether of bisphenol S; novolac type epoxy resins such as phenol novolac epoxy resins, cresol novolac epoxy resins and hydroxybenzaldehydephenol novolac epoxy resin; and polyfunctional epoxy compounds such as glycidyl ether of tetrahydroxydiphenylmethane, glycidyl ether of tetrahydroxybenzophenone and epoxylated polyvinylphenol. Preferable examples among these hydrides of aromatic epoxy compounds include diglycidyl ether of hydrogenated bisphenol A.

Next, the alicyclic epoxy compound will be explained. This alicyclic epoxy compound is a compound containing at least one epoxy group connected to an alicyclic ring in its molecule as shown in the following formula.

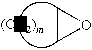

In the formula, m is an integer of 2 to 5.

A group having a structure obtained by removing one or plural hydrogen atoms in (CH₂)ₘ of the above formula may be combined with another chemical structure to form the alicyclic epoxy compound. Also, the hydrogen forming the alicyclic ring may be arbitrarily replaced with a straight-chain alkyl group such as a methyl group or an ethyl group. Among these compounds, compounds having an epoxycyclopentane ring (compounds in which m=3 in the above formula) or an epoxycyclohexane ring (compounds in which m=4 in the above formula) are preferably used. Specific examples of the alicyclic epoxy compound include the following compounds:

3,4-epoxycyclohexylmethyl, 3,4-epoxycyclohexane carboxylate, 3,4-epoxy-6-methylcyclohexylmethyl, 3,4-epoxy-6-methylcyclohexane carboxylate, ethylenebis(3,4-epoxycyclohexanecarboxylate), bis(3,4-epoxycyclohexylmethyl) adipate, bis(3,4-epoxy-6-methylcyclohexylmethyl) adipate, diethylene glycol bis(3,4-epoxycyclohexyl methyl ether), ethylene glycol bis(3,4-epoxycyclohexyl methyl ether), heneicosane (a compound also named as 3,4-epoxycyclohexanespiro-2′,6′-dioxanespiro-3″,5″-dioxanes piro-3′″,4′″-epoxycyclohexane), 4-(3,4-epoxycyclohexyl)-2,6-dioxa-8,9-epoxyspiro[5.5]undecane, 4-vinylcyclohexene dioxide, bis-2,3-epoxycyclopentyl ether and dicyclopentadiene dioxide.

Next, to explain the aliphatic epoxy compound, the aliphatic epoxy compound corresponds to polyglycidyl ethers of an aliphatic polyhydric alcohol or its alkylene oxide addition product. Examples of the aliphatic epoxy compound include diglycidyl ether of 1,4-butanediol, diglycidyl ether of 1,6-hexanediol, triglycidyl ether of glycerin, triglycidyl ether of trimethylolpropane, diglycidyl ether of polyethylene glycol, diglycidyl ether of propylene glycol, and polyglycidyl ethers of polyether polyols obtained by adding one or two or more types of alkylene oxides (ethylene oxide and propylene oxide) to aliphatic polyhydric alcohols such as ethylene glycol, propylene glycol and glycerin.

These epoxy compounds exemplified here may be either singly used or in combinations of two or more.

The epoxy equivalent of the epoxy compound used for the solventless adhesive is generally in a range of from 30 to 3,000 g/equivalent and preferably in a range of from 50 to 1,500 g/equivalent. When the epoxy equivalent is less than 30 g/equivalent, there is the possibility of a reduction in the flexibility of the cured protective film and in adhesion strength. When the epoxy equivalent exceeds 3,000 g/equivalent on the other hand, there is the possibility of a reduction in compatibility with other components.

A cationic polymerization initiator is formulated to cure the epoxy compound by cationic polymerization. The cationic polymerization initiator generates cationic species or a Lewis acid when irradiated with active energy rays such as visual rays, ultraviolet rays, X-rays and electron rays or heated to initiate a polymerization reaction of the epoxy group. Any type of cationic polymerization initiator is preferably provided with latent abilities from the viewpoint of workability.

In the following, the photo-cationic polymerization initiator is described. When the photo-cationic polymerization initiator is used, this enables the epoxy compound to be cured at ambient temperature and decreases the necessity for consideration of the heat resistance of the polarizer and the strain of the polarizer caused by expansion, thereby well adhering the protective film. Also, because the photo-cationic polymerization initiator acts catalytically when irradiated with light, it is superior in storage stability and workability even if it is mixed in the epoxy compound. Examples of the compound that produces cationic species or a Lewis acid when irradiated with active energy rays include onium salts such as aromatic diazonium salts, aromatic iodonium salts and aromatic sulfonium salts and iron-allene complexes. Among these compounds, aromatic sulfonium salts in particular have ultraviolet absorbing characteristics in a wavelength region of 300 nm or more and are therefore superior in curability, so that they can provide a cured product having good mechanical strength and adhesion strength. These aromatic sulfonium salts are therefore preferably used.

These photo-cationic polymerization initiators are available as commercial products in the following trade names: “Kayarad PCI-220” and “Kayarad PCI-620” (manufactured by Nippon Kayaku Co., Ltd.), “UVI-6990” (manufactured by Union Carbide Corporation), “Adecaoptomer SP-150” and “Adecaoptomer SP-170” (manufactured by ADEKA CORPORATION), “CI-5102”, “CIT-1370”, “CIT-1682”, “CIP-1866S”, “CIP-2048S” and “CIP-2064S” (manufactured by Nippon Soda Co., Ltd.), “DPI-101”, “DPI-102”, “DPI-103”, “DPI-105”, “MPI-103”, “MPI-105”, “BBI-101”, “BBI-102”, “BBI-103”, “BBI-105”, “TPS-101”, “TPS-102”, “TPS-103”, “TPS-105”, “MDS-103”, “MDS-105”, “DTS-102” and “DTS-103” (manufactured by Midori Kagaku Co., Ltd.) and “PI-2074” (manufactured by Rohdia). Particularly, “CI-5102” manufactured by Nippon Soda Co., Ltd. is a preferable initiator.

The amount of the photo-cationic polymerization initiator to be compounded is generally 0.5 to 20 parts by weight, preferably 1 part by weight or more and preferably 15 parts by weight or less based on 100 parts by weight of the epoxy compound.

Moreover, a photosensitizer may be combined according to the need. When the photosensitizer is used, the reactivity of the reaction system is improved, making it possible to improve the mechanical strength and adhesion strength of the cured product. Examples of the photosensitizer include carbonyl compounds, organic sulfur compounds, persulfides, redox type compounds, azo and diazo compounds, halogen compounds and photo-reducing dyes. When the photosensitizer is formulated, its amount is about 0.1 to 20 parts by weight based on 100 parts by weight of the photo-cationic polymerizable epoxy resin composition.

Next, the thermal cationic polymerization initiator will be explained. Examples of the compound that generates cation species or a Lewis acid when heated include benzylsulfonium salts, thiophenium salts, thiolanium salts, benzylammonium, pyridinium salts, hydrazinium salts, carboxylates, sulfonates and amineimides. These thermal cationic polymerization initiators are easily available as commercial products in the following trade names: “Adeka Opton CP77” and “Adeka Opton CP66” (manufactured by ADEKA CORPORATION), “CI-2639” and “CI-2624” (manufactured by Nippon Soda Co., Ltd.) and “Sunaid SI-60L”, “Sunaid SI-80L” and “Sunaid SI-100L” (manufactured by Sanshin Chemical Industry Co., Ltd.).

It is also useful techniques that the aforementioned photo-cationic polymerization initiator is combined with the aforementioned thermal cationic polymerization initiator.

The epoxy adhesive may contain compounds promoting cationic polymerization, such as oxetanes and polyols.

In the case of using a solventless adhesive, the adhesive may be applied to the adhesive surface of the protective film made of a propylene resin and/or the polarizer to laminate the both on each other to form a polarizing plate. No particular limitation is imposed on a method of applying a solventless adhesive to the polarizer or the protective film, and for example, various coating methods such as methods using a doctor blade, a wire bar, a die coater, a comma coater or a gravure coater may be utilized. Also, because each coating system is operated in an optimum viscosity range, a small amount of a solvent may be used to regulate the viscosity. Any type of solvent may be used insofar as it well dissolves the epoxy adhesive without deteriorating the optical performance of the polarizer, and organic solvents, for example, hydrocarbons such as toluene and esters such as ethyl acetate may be used. When the epoxy adhesive is used, the thickness of the adhesive layer is usually 50 μm or less, preferably 20 μm or less and more preferably 10 μm or less and also the thickness is usually 1 μm or more.

As mentioned above, after the polypropylene phase difference film is applied to the polarizer with the uncured adhesive layer, the film is irradiated with active energy rays or heated, to thereby cure the epoxy adhesive layer, thereby securing the protective film to the polarizer. When the film is cured by irradiation with active energy rays, ultraviolet rays are preferably used. Specific examples of the ultraviolet rays include a low-pressure mercury lamp, an intermediate-pressure mercury lamp, a high-pressure mercury lamp, a black light lamp and a metal halide lamp. The irradiation strength and exposure dose of ultraviolet rays may be properly selected so as to sufficiently activate the polymerization initiator and so as not to adversely affect the cured adhesive layer, polarizer and phase difference film. Also, when the film is cured by heating, the usually known methods may be used for heating, and the temperature and time at this time may be properly selected in such a manner that the polymerization initiator is sufficiently activated and the cured adhesive layer, polarizer and protective film are not adversely affected.

When the protective film made of a propylene resin is laminated on one surface of the polarizer and the protective film made of a resin other than the propylene resin is laminated on the other surface, the same adhesive as or an adhesive different from the above adhesive may be used for the adhesion of the protective film made of a resin other than the propylene resin. It is however preferable to use the same adhesive for the adhesion between the polarizer and the propylene protective film and for the adhesion between the polarizer and the resin other than the propylene resin from the viewpoint of reducing the number of steps and materials.

In the manufacture of the polarizer, the protective film made of a propylene resin is preferably subjected to corona discharge treatment to treat the surface on the side applied to the polarizer. This corona discharge treatment improves the adhesion between the protective film made of a propylene resin and the polarizer. The corona discharge treatment means treatment in which a high voltage is applied across electrodes to discharge thereby activating the resin film disposed between the electrodes. The effect of the corona discharge treatment varies depending on the type of electrodes, interval between electrodes, voltage, humidity and the type of the resin film to be used. However, the corona discharge treatment is preferably carried out, for example, in the following conditions: interval between the electrodes is 1 to 5 mm and the traveling speed is about 3 to 20 m/min. After the corona discharge treatment, the polarizer is applied to the treated surface with the aforementioned adhesive.

Thus, a polarizing plate is obtained in which the protective film made of a propylene resin is laminated on one surface of the polarizer made of a polyvinyl alcohol resin and the protective film made of the same or different resin is laminated on other surface.

The polarizing plate obtained in this manner may be produced as a polarizing plate with a pressure-sensitive adhesive by forming a pressure-sensitive adhesive layer on the outside of one of the protective films. In this case, the surface of the pressure-sensitive adhesive layer is usually covered with a peelable film. When different types of protective films are laminated on both surfaces of the polarizer, the pressure-sensitive adhesive layer may be formed either on the side of the protective film made of a propylene resin or on the side of the protective film made of a resin other than the propylene resin. However, in many cases, the pressure-sensitive adhesive layer is formed on the side of the protective film made of a propylene resin in general and a liquid crystal cell is applied to this side.

### [Laminated Optical Member]

When the polarizing plate is used, an optical layer exhibiting an optical function other than a polarizing function may be provided on one of the protective films to form a laminated optical member. Examples of the optical layer to be laminated on the polarizing plate for the purpose of forming the laminated optical member include various materials used to form a liquid crystal display device such as a reflecting layer, a semi-transmissive reflecting layer, a light diffusion layer, a phase difference film, a converging sheet and a luminance improving film. Among these materials, the reflecting layer, the semi-transmissive reflecting layer and the light diffusion layer are used in the case of forming laminated optical members constituted of polarizing plates of a reflecting type, a semi-transmissive type and a diffusion type or combinations of these types.

The reflecting type polarizing plate is used in a liquid crystal display device of a type in which incident light from the visible side is reflected to display the reflected light, and serves to make a thinner liquid crystal display device because a light source such as a back light can be omitted. Also, the semi-transmissive type polarizing plate is used as a reflecting type in a bright place and for a liquid crystal display device of a type displaying by a light source such as a back light in a dark place. In the case of the laminated optical member serving as a reflecting type polarizing plate, a foil or a deposited film made of a metal such as aluminum may be applied to the protective film on the polarizer to form a reflecting layer. The laminated optical member serving as the semi-transmissive type polarizing plate may be formed by using the above reflecting layer as a half mirror or by adhering a reflecting plate made to contain a pearl pigment to exhibit light transmittance, to the polarizing plate. In the case of the laminated optical member as the diffusion type polarizing plate, on the other hand, a fine irregular structure is formed on the surface by using various methods such as a method in which the protective film on the polarizing plate is subjected to matt treatment, a method in which a resin containing microparticles is applied and a method in which a film containing microparticles is applied.

Moreover, the laminated optical member serving as the polarizing plate for both reflecting and diffusing purposes may be formed, for example, by a method in which, on the fine irregular structural surface of the diffusion type polarizing plate, a reflecting layer is formed on which the irregular structure is reflected. The reflecting layer having the fine irregular structure has, for example, an advantage that it diffuses incident light by irregular reflection to prevent directivity and glare and to limit the unevenness of the contrast between light and shade. Also, the resin layer and film containing microparticles have an advantage that incident light and its reflected light are diffused when they transmit the microparticle-containing layer to thereby further limit the unevenness of the contrast between light and shade. The reflecting layer on which the surface fine irregular structure is reflected may be formed by applying a metal directly on the surface of the fine irregular structure by a method of deposition or plating such as vacuum deposition, ion plating, or sputtering. As the microparticles to be formulated to form the surface fine irregular structure, the following microparticles having an average particle diameter of 0.1 to 30 μm may be utilized, the particles including inorganic microparticles such as silica, aluminum oxide, titanium oxide, zirconia, tin oxide, indium oxide, cadmium oxide and antimony oxide and organic microparticles made of crosslinked or non-crosslinked polymers.

On the other hand, the phase difference film as the aforementioned optical layer is used for the purpose of, for example, compensating the phase difference of a liquid crystal cell. Examples of the phase difference film include birefringence films made of, for example, stretched films of various plastics, films obtained by aligning and fixing a discotheque liquid crystal or a nematic liquid crystal and those obtained by forming the above liquid crystal layer on a film substrate. In this case, a cellulose resin film such as triacetylcellulose is preferably used as the film substrate to support the aligned liquid crystal layer.

Examples of the plastic used to form the birefringence film include polycarbonate, polyvinyl alcohol, polystyrene, polymethylmethacrylate, polyolefins such as polypropylene, polyallylates and polyamides. The stretched film may be one treated by an appropriate system such as a uniaxial or biaxial system. Also, the stretched film may be a birefringence film obtained by applying a shrinkage force and/or a stretching force under adhesion with a heat shrinkable film to control the refractive index in the direction of the film thickness. In this case, these phase difference films may be used in combinations of two or more with the intention of controlling optical characteristics such as broad-band performance.

The converging sheet is used for the purpose of controlling, for example, the optical path and may be formed as a prism array sheet, a lens array sheet or a sheet with dots.

A film improved in brightness is used for the purpose of improving brightness in a liquid crystal display device or the like. Examples of the film include reflection type polarizing separating sheets so designed that anisotropy of films arises by laminating plural thin films differing in the anisotropy of the refractive index from each other and circularly polarized light separating sheets in which an aligned film of a cholesteric liquid crystal polymer or its aligned liquid crystal layer is supported on a film substrate.

The laminated optical member may be a two-layer or three- or more-layer laminate by combining the polarizing plate and one or two or more optical layers selected from the aforementioned reflecting layer or semi-transmissive type reflecting layer, light diffusing layer, phase difference film, converging sheet and brightness-improved film depending on the purpose of use. In this case, the optical layers such as a light diffusing layer, a phase difference film, a converging sheet and a brightness-improved film may be formed by combining two or more each. No particular limitation is imposed on the arrangement of each optical layer.

Various optical layers forming the laminated optical member are integrated using an adhesive. In this case, any adhesive may be used without any particular limitation insofar as the adhesive layer is satisfactorily formed. It is preferable to use a pressure-sensitive adhesive from the viewpoint of, for example, simplicity of adhesion work and prevention of the generation of optical strain.

Such a laminated optical member is also applied to a liquid crystal cell with its desired surface facing the liquid crystal cell using a pressure-sensitive adhesive. As the pressure-sensitive adhesive, those using a base polymer such as an acrylate polymer, a methacrylate polymer, a butyl rubber polymer or a silicone polymer may be used. Although no particular limitation is imposed on the type of the pressure-sensitive adhesive, polymers using, as the base, a (meth)acrylate such as butyl(meth)acrylate, ethyl(meth)acrylate, isooctyl(meth)acrylate or 2-ethylhexyl(meth)acrylate or polymers using, as the base, a copolymer using two or more of these (meth)acrylates are preferably used. The pressure-sensitive adhesive generally contains a polar monomer copolymerized with these base polymers. Examples of such a polar monomer include monomers having a carboxyl group, a hydroxyl group, an amino group or an epoxy group, such as (meth)acrylic acid, 2-hydroxyethyl(meth)acrylate, 2-hydroxypropyl(meth)acrylate, (meth) acrylamide, N,N-dimethylaminoethyl(meth)acrylate and glycidyl(meth)acrylate. Examples of the crosslinking agent include divalent or polyvalent metal salts which react with a carboxyl group to form metal carboxylates and polyisocyanate compounds which react with a carboxyl group to form an amide bond. One or two or more of these compounds are mixed in a base polymer upon use. The thickness of general pressure-sensitive adhesives is about 5 to 50 μm. When the pressure-sensitive adhesive layer is applied to the polarizing plate, the surface of the protective film of the polarizing plate may be subjected to surface treatment such as corona treatment depending on the situation.

### [Liquid Crystal Display Device]

The polarizing plate of the present invention may be applied to a liquid crystal cell with a pressure-sensitive adhesive in the condition that it is laminated on other optical layers as mentioned above according to the need to make a liquid crystal display device. In the production of the liquid crystal display device, a pressure-sensitive layer is formed on the outside of one of the protective film to make a polarizing plate with a pressure-sensitive adhesive as mentioned above and the polarizing plate is applied to the liquid crystal cell in such a manner that the pressure-sensitive adhesive layer side is facing the liquid crystal cell. In the case of the laminated optical member, there is the case where the polarizing plate is applied in such a manner that the surface other than the surface of the protective film is facing the liquid crystal cell. The liquid crystal cell constituting the liquid crystal display device is allowed to have various modes known in this field such as TN (twisted nematic), STN (super twisted nematic), VA (vertical alignment) and IPS (in-plane switching).

The present invention will be explained in more detail by way of examples, which are not intended to be limiting the present invention, in which all designations of parts and % expressing the content or amount to be used indicate parts by weight and weight percentage (wt. %), respectively, unless otherwise noted.

### EXAMPLE 1

### (a) Preparation of Aqueous Adhesive

3 Parts of a carboxyl group-modified polyvinyl alcohol “Kuraray Poval KL-318” obtained from Kuraray Co., Ltd. was dissolved in 100 parts of water, to which was further added 1.5 parts of a water-soluble polyamide epoxy resin “SUMIREZ Resin 650” (aqueous solution having a solid content of 30%) obtained from Sumika Chemtex Co., Ltd to prepare an adhesive.

(b) Manufacture of Polarizing Plate with Protective Film

A protective film (“KC8UX” obtained from Konica Minolta Opto, Inc.) made of triacetylcellulose was applied to one surface of a polarizer in which iodine was adsorbed to and aligned on a polyvinyl alcohol film with the adhesive prepared in (a). Separately, one surface of a 20-μm-thick film made of a propylene/ethylene random copolymer (“Sumitomo Nobren W151” obtained from Sumitomo Chemical Co., Ltd.) containing about 5% of an ethylene unit was subjected to corona discharge treatment in the condition of an integrated exposure dose of 1,680 J. This corona-treated surface was applied to the surface of the polyvinyl alcohol film of the polarizer with the triacetyl cellulose film applied to one surface thereof with the same adhesive prepared in the above (a) within 30 seconds after this corona discharge treatment, followed by drying at 80° C. for 5 minutes. The resulting film was further cured at 40° C. for 3 days to obtain a polarizing plate in which the protective film made of triacetylcellulose was laminated on one surface of the polarizer and the protective film made of a propylene resin was laminated on the other surface.

### (c) Evaluation of Adhesion; Warm-Water Dipping Test

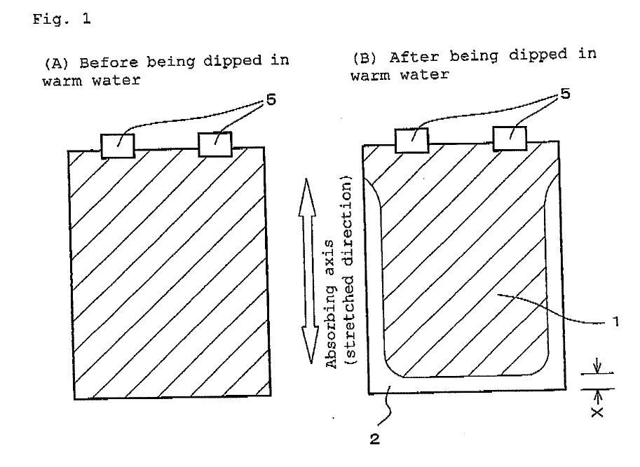

The polarizing plate with a protective film obtained above was subjected to the warm-water dipping test shown below to evaluate the adhesion between the protective film and the polarizer. Specifically, the polarizing plate was cut into a size of 30 mm×80 mm with the absorbing axis (stretched direction) being the long side to prepare a sample, and the dimension in the direction of the long side was measured precisely. One short side of this sample was held by a holding part 5 as shown in FIG. 1A to dip 80% (in the direction of the length) of the sample in a water bath and the sample was kept for 240 minutes in this condition. After that, the sample was taken out of the water bath, followed by wiping water and then, the dimension of the sample in the direction of the length was measured to define the (Length before the test−Length after the test) as the amount of shrinkage of the polarizing plate. Also, as shown in FIG. 1A, the entire surface of the sample uniformly exhibited the color specific to the polarizing plate before the sample was dipped in warm water. However, when the sample was dipped in warm water, iodine was eluted from the periphery of the polarizer at a part in contact with warm water to give rise to a part 2 where a color is lost in the periphery of the polarizing plate. Then, the length X from the edge of the sample to the end of a part 1 where a color specific to a polarizing plate is left was measured as the amount of color voids of the polarizing plate (this amount of color voids itself is a value in the direction of the absorbing axis of the polarizing plate). With regard to the polarizing plate obtained in this example, the amount of shrinkage was 0.70 mm and the amount of color voids was 1.50 mm.

### EXAMPLE 2

In this example, an epoxy ultraviolet curable adhesive was used to adhere the polarizer with the protective film. This adhesive contained an alicyclic epoxy compound and a photo-cationic polymerization initiator. As the polarizer, the triacetylcellulose film and the propylene resin film, the same materials as those used in Example 1 were used. First, the triacetylcellulose film was applied to one surface of the polarizer with the above epoxy adhesive. Separately, one surface of a propylene resin film was subjected to corona discharge treatment in the condition of an integrated exposure dose of 1,680 J. This corona-treated surface was applied to the surface of the polyvinyl alcohol film of the polarizer with the triacetyl cellulose film applied to one surface thereof with the same epoxy adhesive within 30 seconds after this corona discharge treatment. After that, using ultraviolet-ray radiation system manufactured by Fusion UV Systems, ultraviolet rays were irradiated from the propylene resin film side in the following conditions: power: 1,000 mW, exposure dose: 500 mJ, to cure the adhesive. Thus, a polarizing plate was obtained in which the protective film made of triacetylcellulose was laminated on one surface of the polarizer with the epoxy ultraviolet-ray curable adhesive and the protective film made of a propylene resin was laminated on the other surface with the epoxy type ultraviolet-ray curable adhesive. This polarizing plate was subjected to the warm-water dipping test in the same manner as in the above (c) of Example 1. With regard to the polarizing plate obtained in this example, the amount of shrinkage was 0.10 mm and the amount of color voids was 1.00 mm.

### COMPARATIVE EXAMPLE 1

A polarizing plate (“SRW062A”, commercially available from Sumitomo Chemical Co., Ltd.) in which protective films made of triacetylcellulose were applied to both surfaces of a polarizer in which iodine was adsorbed to and aligned on a polyvinyl alcohol film was subjected to the warm-water dipping test in the same manner as in the above (c) of Example 1. As a result, the amount of shrinkage was 1.00 mm and the amount of color voids was 2.07 mm.

The results of the above examples and comparative example are collectively shown in Table 1. As is clear from the results, the polarizing plate of the present invention is decreased in the amount of shrinkage and in the amount of color voids in the warm-water dipping test and is therefore superior in durability under moistened and heated conditions,

TABLE 1

| | Amount of shrinkage | Amount of color voids |
|---|---|---|
| Example 1 | 0.70 mm | 1.50 mm |
| Example 2 | 0.10 mm | 1.00 mm |
| Comparative | 1.00 mm | 2.07 mm |
| Example 1 | | |

### EXAMPLE 3

One droplet of toluene was dropped on a 20 μm-thick film formed of the same propylene/ethylene copolymer “Sumitomo Nobren W151” that was used in Example 1 and then, the film was allowed to stand for 5 minutes. Then, the surface of the film was observed, with the result that no change was found.

### COMPARATIVE EXAMPLE 2

One droplet of toluene was dropped on a norbornene resin film (“ZF-100” available from OPTES INC.) which was used for the protective film of a polarizing plate and then, the film was allowed to stand for 5 minutes. Then, the surface of the film was observed, with the result that the part where toluene was dropped was eroded and roughened.

In the polarizing plate of the present invention, the protective film disposed on at least one surface of the polarizer is constituted of a propylene resin. Therefore, the polarizing plate of the present invention is more resistant to the peeling of the polarizer from the protective film even under moistened and heated conditions and is therefore superior in adhesion as compared with a polarizing plate in which protective films made of an acetylcellulose resin are laminated on both surfaces of the polarizer. The laminated optical member obtained by laminating other optical layers on this polarizing plate is also superior in the adhesion between the polarizer and the protective film. Also, these polarizing plate and laminated optical member are also superior in solvent resistance.

Moreover, when the propylene resin is laminated on the polarizer, the surface of the propylene resin film on the side to be applied to the polarizer is subjected to corona discharge treatment,

whereby such higher adhesion is surely obtained.

1. A polarizing plate comprising a polarizer made of a polyvinyl alcohol resin film with a dichroic dye adsorbed thereto and aligned thereon and protective films laminated on both surfaces of the polarizer, wherein at least one of the protective films is made of a propylene resin.

2. The polarizing plate according to claim 1, wherein the protective film made of a propylene resin is constituted of a copolymer primarily containing a propylene unit and containing 1 to 10% by weight of an ethylene unit.

3. The polarizing plate according to claim 1, wherein the protective film made of a propylene resin has an in-plane phase difference of 10 nm or less.

4. The polarizing plate according to claim 1, wherein a protective film made of a propylene resin is laminated on one surface of the polarizer and a protective film made of a cellulose acetate resin is laminated on the other surface.

5. The polarizing plate according to claim 1, wherein the polarizer and the protective film made of a propylene resin are laminated with an aqueous adhesive.

6. The polarizing plate according to claim 5, wherein the aqueous adhesive contains a crosslinkable epoxy resin.

7. The polarizing plate according to claim 1, wherein the polarizer and the protective film made of a propylene resin are laminated with a solventless epoxy adhesive.

8. The polarizing plate according to claim 7, wherein the solventless epoxy adhesive is cured by cationic polymerization by heating or irradiation with active energy rays.

9. A method for manufacturing a polarizing plate, comprising laminating a protective film made of a propylene resin on at least one surface of a polarizer made of a polyvinyl alcohol resin film with a dichroic dye adsorbed thereto and aligned thereon, wherein when the protective film is laminated, the surface of the protective film made of the propylene resin, which surface is to be applied to the polarizer, is subjected to corona discharge treatment and then the polarizer is applied to the treated surface with an adhesive.

10. A laminated optical member comprising a laminate of the polarizing plate as claimed in claim 1 and optical layer having other optical functions.

11. The laminated optical member according to claim 10, wherein the optical layer is a phase difference film.

12. A liquid crystal display device wherein the polarizing plate as claimed in claim 1 is applied to a liquid crystal cell with a pressure-sensitive adhesive.

13. A liquid crystal display device wherein the laminated optical member as claimed in claim 10 is applied to a liquid crystal cell with a pressure-sensitive adhesive.
